(19) United States
(12) Patent Application Publication
(10) Pub. No.: US 2013/0318021 A1
(43) Pub. Date: Nov. 28, 2013

(54) INFORMATION PROCESSING APPARATUS, INFORMATION PROCESSING METHOD, AND PROGRAM

(71) Applicant: SONY CORPORATION, Tokyo (JP)

(72) Inventors: Kei Tateno, Tokyo (JP); Seiichi Takamura, Saitama (JP)

(73) Assignee: Sony Corporation, Tokyo (JP)

(21) Appl. No.: 13/859,112

(22) Filed: Apr. 9, 2013

(30) Foreign Application Priority Data
May 28, 2012 (JP) 2012-120725

(51) Int. Cl. G06N 5/02

(52) U.S. Cl. CPC G06N 5/02
USPC 706/46

(57) ABSTRACT

There is provided an information processing apparatus including an experience information extracting unit that extracts experience information which is information regarding an experience, from text data input from a user, an item selecting unit that performs at least one of extraction and priority setting of an item to be provided to the user, based on the extracted experience information, and a provision control unit that controls provision of the item to the user, based on a result of the extraction or the priority setting of the item.

### BACKGROUND

The present disclosure relates to an information processing apparatus, an information processing method, and a program and more particularly, to an information processing apparatus, an information processing method, and a program that are used suitably when items are recommended for a user.

In the related art, technology for changing items to be recommended according to the behavior of a user to enable easy reception of the items in a recommendation system for recommending various items such as content for the user has been suggested (for example, refer to JP 4433326B).

Recently, services for causing a user to easily contribute text data showing opinions of the user and open the text data to the public, such as Twitter (registered trademark), have been developed. Therefore, technology for extracting the behavior or feelings of a user from the text data has been actively developed (for example, refer to Kobayashi, N., et al., “Opinion Mining from Web Documents: Extraction and Structurization,” The Japanese Society for Artificial Intelligence, 2007). Further, technology for extracting evaluation information from an evaluation sentence input by a user and learning the taste of the user has been suggested (for example, JP 2011-39811A).

### SUMMARY

Under such situation, when the items are recommended on the basis of the text data input from the user, it has been requested to make the possibility of the user receiving the recommended items become high.

It is desirable to enable the possibility of a user receiving recommended items to become high.

According to an embodiment of the present disclosure, there is provided an information processing apparatus including an experience information extracting unit that extracts experience information which is information regarding an experience, from text data input from a user, an item selecting unit that performs at least one of extraction and priority setting of an item to be provided to the user, based on the extracted experience information, and a provision control unit that controls provision of the item to the user, based on a result of the extraction or the priority setting of the item.

The experience information extracting unit may classify an experience included in the experience information into a predetermined classification. The item selecting unit may perform at least one of the extraction and the priority setting of the item to be provided to the user, based on the classification of the experience.

The item selecting unit may perform at least one of the extraction and the priority setting of the item to be provided to the user, based on a time or a place included in the experience information.

The experience information may be information regarding an experience related to the item.

The information processing apparatus may further include a subjective expression extracting unit that extracts a subjective expression from the text data.

The item selecting unit may perform at least one of the extraction and the priority setting of the item to be provided to the user, further based on the extracted subjective expression.

The item selecting unit may perform at least one of the extraction and the priority setting of the item to be provided to the user, based on whether the subjective expression is positive or negative.

The item selecting unit may perform at least one of the extraction and the priority setting of the item to be provided to the user, when the experience information and the subjective expression that is positive are extracted from the text data.

The item selecting unit may perform at least one of the extraction and the priority setting of the item to be provided to the user, based on a mood shown by the subjective expression.

The item selecting unit may perform at least one of the extraction and the priority setting of the item to be provided to the user, based on whether the subjective expression is a simple evaluation or an emotional expression.

The information processing apparatus may further include a keyword extracting unit that extracts a keyword from the text data. The item selecting unit may perform at least one of the extraction and the priority setting of the item to be provided to the user, based on the extracted keyword.

The keyword may include a name of the item. The item selecting unit may perform at least one of the extraction and the priority setting of the item to be provided to the user, based on the name of the item extracted as the keyword.

The keyword may include a name of a person or a group related to the item. The item selecting unit may perform at least one of the extraction and the priority setting of the item to be provided to the user, based on the name of the person or the group extracted as the keyword.

The provision control unit may perform control in a manner that an item of which extraction or priority setting has been performed is provided together with the text data.

The provision control unit may perform control in a manner that an item of which extraction or priority setting has been performed based on a plurality of pieces of the text data satisfying a predetermined condition is collected and is provided to the user.

According to an embodiment of the present disclosure, there is provided an information processing method performed by an information processing apparatus, the method including extracting experience information which is information regarding an experience, from text data input from a user, performing at least one of extraction and priority setting of an item to be provided to the user, based on the extracted experience information, and controlling provision of the item to the user, based on a result of the extraction or the priority setting of the item.

According to an embodiment of the present disclosure, there is provided a program for causing a computer to execute processing including extracting experience information which is information regarding an experience, from text data input from a user, performing at least one of extraction and priority setting of an item to be provided to the user, based on the extracted experience information, and controlling provision of the item to the user, based on a result of the extraction or the priority setting of the item.

According to the embodiment of the present disclosure, the experience information to be the information regarding the experience is extracted from the text data input from the user, at least one of the extraction and the priority setting of the items to be provided to the user is performed, based on the extracted experience information, and the provision of the item to the user is controlled based on the result of the extraction or the priority setting of the item.

According to the embodiments of the present disclosure described above, the possibility of a user receiving recommended items can be made to become high.

### BRIEF DESCRIPTION OF THE DRAWINGS

FIG. 1 is a block diagram showing an embodiment of an information processing system to which the present disclosure is applied;

FIG. 2 is a block diagram showing a configuration example of a function of a server;

FIG. 3 is a flowchart showing content recommendation processing:

FIG. 4 is a diagram showing a configuration example of a text DB;

FIG. 5 is a diagram showing an example of a data configuration of a subjective expression dictionary;

FIG. 6 is a diagram showing an example of an extraction result of a subjective expression;

FIG. 7 is a diagram showing an example of a data configuration of an experience classification dictionary;

FIG. 8 is a diagram showing an example of a data configuration of a time information dictionary;

FIG. 9 is a diagram showing an example of a data configuration of a place information dictionary;

FIG. 10 is a diagram showing an example of an extraction result of experience information;

FIG. 11 is a diagram showing an example of an extraction result of a keyword;

FIG. 12 is a flowchart showing the detail of recommended content extraction processing;

FIG. 13 is a diagram showing a configuration example of a content information DB;

FIG. 14 is a flowchart showing the detail of ranking classification selection processing:

FIG. 15 is a diagram showing a configuration example of a representative content DB;

FIG. 16 is a diagram showing a first example of a content recommendation screen;

FIG. 17 is a diagram showing a second example of a content recommendation screen;

FIG. 18 is a diagram showing a third example of a content recommendation screen; and

FIG. 19 is a block diagram showing a configuration example of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.

### 1. Embodiment

### 2. Modifications

### 1. Embodiment

### [Configuration Example of Information Processing System 1]

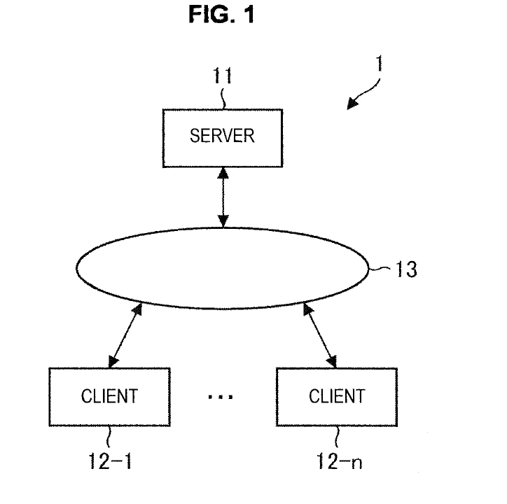

FIG. 1 is a block diagram showing an embodiment of an information processing system to which the present disclosure is applied.

An information processing system 1 includes a server 11 and clients 12-1 to 12-n. The server 11 and the clients 12-1 to 12-n are mutually connected through a network 13.

Hereinafter, when it is not necessary to individually distinguish the clients 12-1 to 12-n, the clients 12-1 to 12-n are simply referred to as the clients 12.

The server 11 provides a service for distributing or recommending content to be a kind of various items (hereinafter, referred to as the content provision service) to each client 12. The server 11 provides a service for receiving a contribution of text data transmitted from the client 12 and showing a comment of each user and opening the text data to the public (hereinafter, referred to as the contribution service). The content of the text data that is contributed by the user is not limited in particular.

Hereinafter, explanation is given on the basis of an example of the case in which the server 11 distributes or recommends music to be a kind of content.

### [Configuration Example of Server 11]

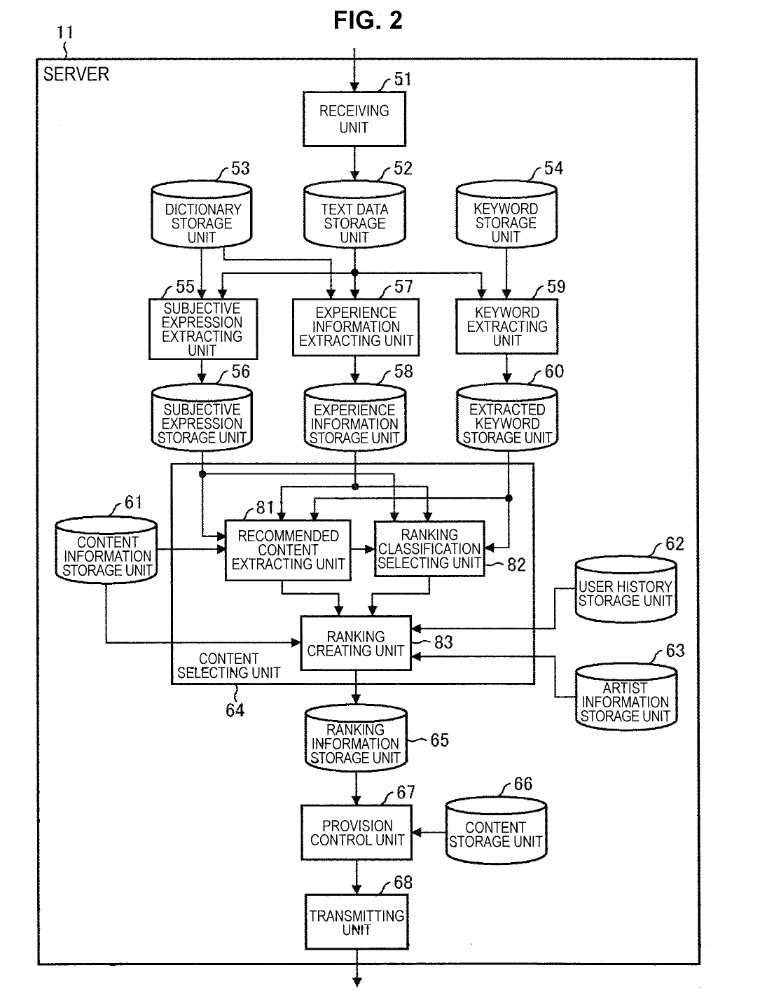

FIG. 2 mainly shows a configuration example of a portion of a function of the server 11 that recommends content. The server 11 includes a receiving unit 51, a text data storage unit 52, a dictionary storage unit 53, a keyword storage unit 54, a subjective expression extracting unit 55, a subjective expression storage unit 56, an experience information extracting unit 57, an experience information storage unit 58, a keyword extracting unit 59, an extracted keyword storage unit 60, a content information storage unit 61, a user history storage unit 62, an artist information storage unit 63, a content selecting unit 64, a ranking information storage unit 65, a content storage unit 66, a provision control unit 67, and a transmitting unit 68.

The receiving unit 51 performs communication with each client 12 or another server (not shown in the drawings) through the network 13 and receives various data or commands relating to a service provided by the server 11. For example, the receiving unit 51 receives the text data generated and contributed by each user, from each client 12 or another server. The receiving unit 51 stores the received text data in the text data storage unit 52.

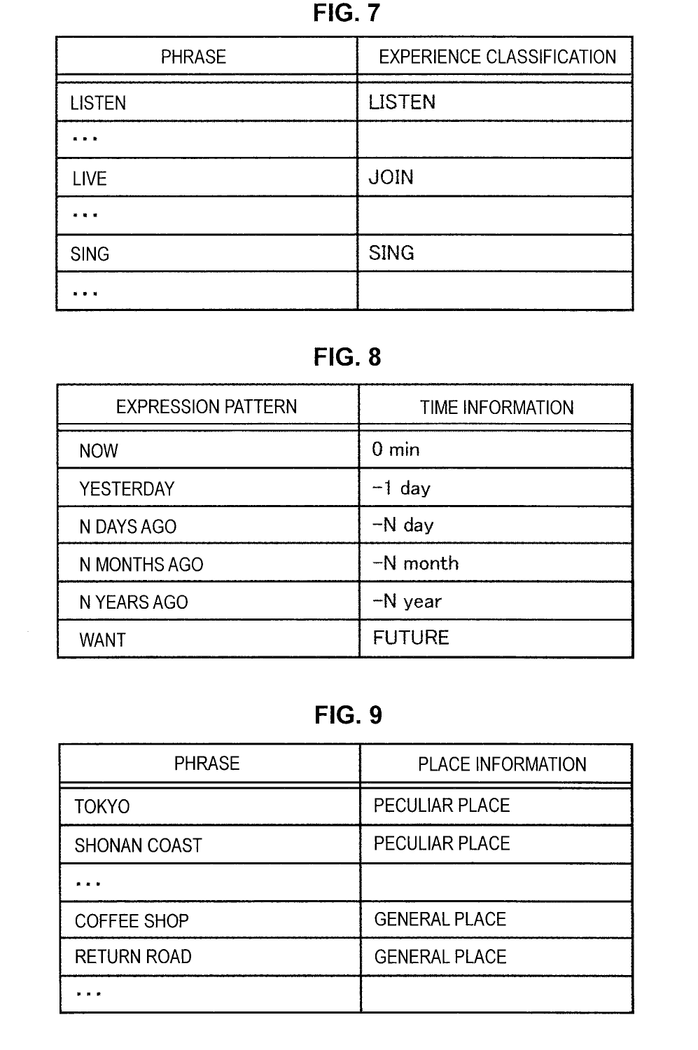

The dictionary storage unit 53 stores various dictionaries. For example, the dictionary storage unit 53 stores a subjective expression dictionary to be described below with reference to FIG. 5, an experience classification dictionary to be described below with reference to FIG. 7, a time information dictionary to be described below with reference to FIG. 8, and a place information dictionary to be described below with reference to FIG. 9.

The keyword storage unit 54 stores a keyword DB (database) in which a keyword to be extracted from the text data is registered.

The subjective expression extracting unit 55 extracts a subjective expression to be an expression showing subjectivity of the user, from the text data stored in the text data storage unit 52. The subjective expression extracting unit 55 determines whether the extracted subjective expression is a positive expression or a negative expression. The subjective expression extracting unit 55 calculates an attribute of the extracted subjective expression, using the subjective expression dictionary stored in the dictionary storage unit 53. The subjective expression extracting unit 55 stores an extraction result of the subjective expression in the subjective expression storage unit 56.

The experience information extracting unit 57 extracts experience information to be information regarding an experience of the user, from the text data stored in the text data storage unit 52, using the experience classification dictionary, the time information dictionary, and the place information dictionary stored in the dictionary storage unit 53. The experience information extracting unit 57 stores an extraction result of the experience information in the experience information storage unit 58.

The keyword extracting unit 59 extracts a keyword from the text data stored in the text data storage unit 52, using the keyword DB stored in the keyword storage unit 54. The keyword extracting unit 59 stores an extraction result of the keyword in the extracted keyword storage unit 60.

The content information storage unit 61 stores information regarding content that can be provided by the sever 11. For example, the content information storage unit 61 stores a content information DB (database) showing an attribute or a feature amount of each content and a representative content DB (database) showing a representative degree of each content for each artist.

The user history storage unit 62 collects a history of the behavior of each user using a service provided by the server 11 and stores the history. For example, the user history storage unit 62 collects a use history of content of each user and stores the history.

The artist information storage unit 63 stores information regarding an artist of content that can be provided by the server 11. For example, the artist information storage unit 63 stores an artist information DB (database) in which a feature amount or metadata of each artist is registered and data showing a correlative relationship between artists.

The content selecting unit 64 performs at least one of extraction and priority setting of content provided to be recommended for the user (hereinafter, referred to as the recommended content). The content selecting unit 64 includes a recommended content extracting unit 81, a ranking classification selecting unit 82, and a ranking creating unit 83.

The recommended content extracting unit 81 extracts recommended content, on the basis of the extraction result of the subjective expression stored in the subjective expression storage unit 56, the extraction result of the experience information stored in the experience information storage unit 58, the extraction result of the keyword stored in the extracted keyword storage unit 60, and the content information DB stored in the content information storage unit 61. The recommended content extracting unit 81 notifies the ranking classification selecting unit 82 and the ranking creating unit 83 of the extraction result of the recommended content.

The ranking classification selecting unit 82 selects a classification of ranking of the recommended content created by the ranking creating unit 83, on the basis of the extraction result of the subjective expression stored in the subjective expression storage unit 56, the extraction result of the experience information stored in the experience information storage unit 58, and the extraction result of the keyword stored in the extracted keyword storage unit 60. The ranking classification selecting unit 82 notifies the ranking creating unit 83 of the selection result of the ranking classification.

The ranking creating unit 83 creates the ranking of the recommended content, using the representative content DB stored in the content information storage unit 61, the user history of the content of each user stored in the user history storage unit 62, and the artist information DB stored in the artist information storage unit 63. The ranking creating unit 83 stores ranking information showing the created ranking in the ranking information storage unit 65.

The content storage unit 66 stores data of content that can be provided by the server 11.

The provision control unit 67 generates display control data to display a screen to provide the recommended content to the user, on the basis of the ranking information stored in the ranking information storage unit 65 and the information of each content stored in the content storage unit 66. The provision control unit 67 supplies the display control data to the transmitting unit 68. The provision control unit 67 reads data of content to be provided to the client 12 from the content storage unit 66 and supplies the data to the transmitting unit 68, according to a request from the client 12.

The transmitting unit 68 performs communication with each client 12 or another server (not shown in the drawings) through the network 13 and transmits various data or commands relating to a service provided by the server 11. For example, the transmitting unit 68 transmits the data of the content or the display provision data generated by the provision control unit 67 to the client 12 through the network 13.

### [Content Recommendation Processing]

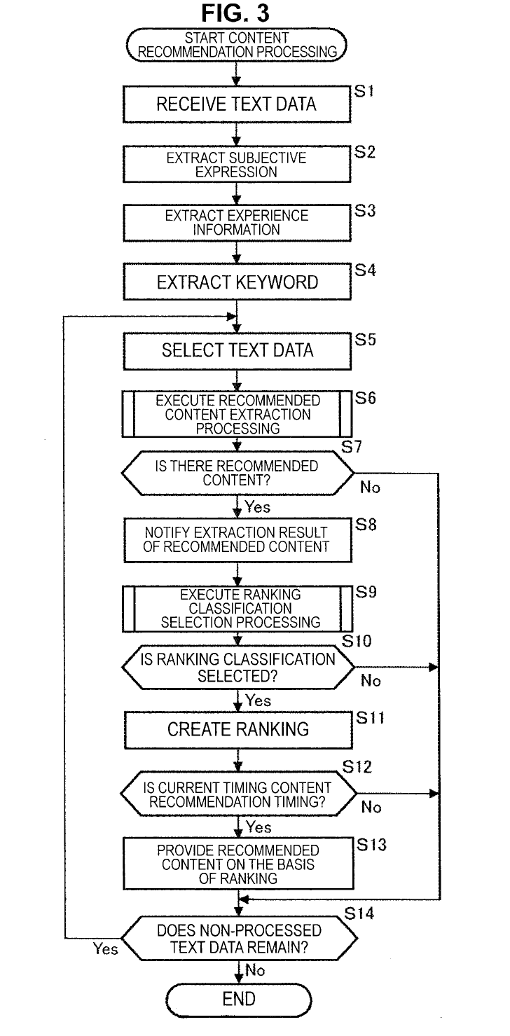

Next, content recommendation processing that is executed by the server 11 will be described with reference to a flowchart of FIG. 3.

In step S1, the receiving unit 51 receives the text data.

For example, the user inputs text data such as a diary, a comment, and a review to the client 12, using a service that can contribute at least the text data, such as a weblog, an electronic bulletin board, a user evaluation column of a product sale site, and a moving image contribution site. This service may be a part of a contribution service provided by the server 11 or may be a service provided by another server (not shown in the drawings).

For example, the receiving unit 51 receives the text data input by the user and information (for example, a user name and a user ID) showing a user (that is, a contributor) of a source directly, through the network 13. Alternatively, the receiving unit 51 receives text data and information showing a user of a source accumulated in another server providing the service, through the network 13. The receiving unit 51 registers the received text data in the text DB (database) stored in the text data storage unit 52.

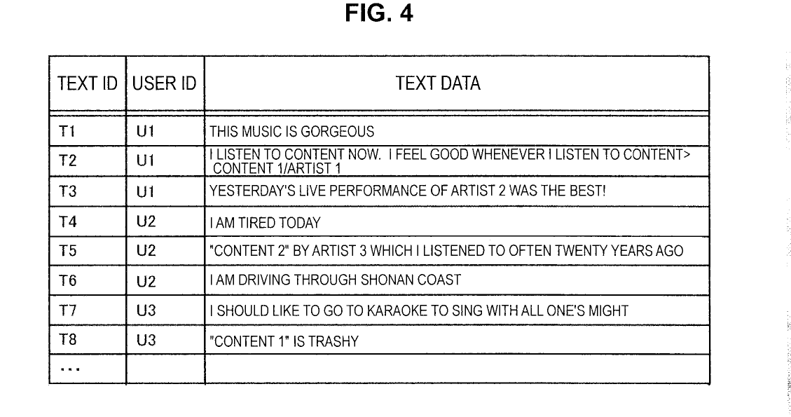

FIG. 4 shows a configuration example of the text DB. The text DB includes items of a text ID, a user ID, and text data.

The text 1D is identification information to identify each text data.

The user ID is identification information to identify each user corresponding to the source of the text data.

The text data is text data that is actually contributed by the user. In FIG. 4, in portions that are described like content 1 and an artist 1, a specific content name or a specific artist name are input in actuality.

In this example, text data of which a text ID is T1 shows “this music is gorgeous!” that is contributed by a user of which a user ID is U1.

Hereinafter, the following processing will be described using the case of executing processing with respect to text data T1 to T8 of FIG. 4 as a specific example.

In step S2, the subjective expression extracting unit 55 extracts a subjective expression. Specifically, the subjective expression extracting unit 55 extracts the subjective expression from the text data received by the processing of step S1 and stored in the text data storage unit 52, using a predetermined method. The subjective expression extracting unit 55 determines whether the extracted subjective expression is a positive expression or a negative expression.

As a method of extracting the subjective expression from the text data and determining whether the extracted subjective expression is a positive expression or a negative expression, any method such as a method described in Kobayashi, N., et al., “Opinion Mining from Web Documents: Extraction and Structurization,” The Japanese Society for Artificial Intelligence, 2007 described above may be adopted.

The subjective expression extracting unit 55 calculates an attribute of the extracted subjective expression, using the subjective expression dictionary stored in the dictionary storage unit 53.

FIG. 5 shows an example of a data configuration of the subjective expression dictionary. In the subjective expression dictionary, a large number of subjective expressions that show subjective expressions of people are registered. In the subjective expression dictionary, two kinds of attributes of a type and a mood are defined with respect to each subjective expression.

The type of the subjective expression is classified by any one of a simple evaluation and an emotional expression. As a subjective expression of a simple evaluation type, an expression showing a simple expression that can be replaced by likes/dislikes or a five-step evaluation is exemplified. As a subjective expression of an emotional expression type, an expression to describe what the user has felt, which is difficult to express by the simple evaluation, is exemplified.

The mood shows feelings or an atmosphere that is shown by the subjective expression and a value of COOL or HAPPY is set to the mood.

In this example, a type of a subjective expression “gorgeous” is defined as an emotional expression and a mood is defined as cool.

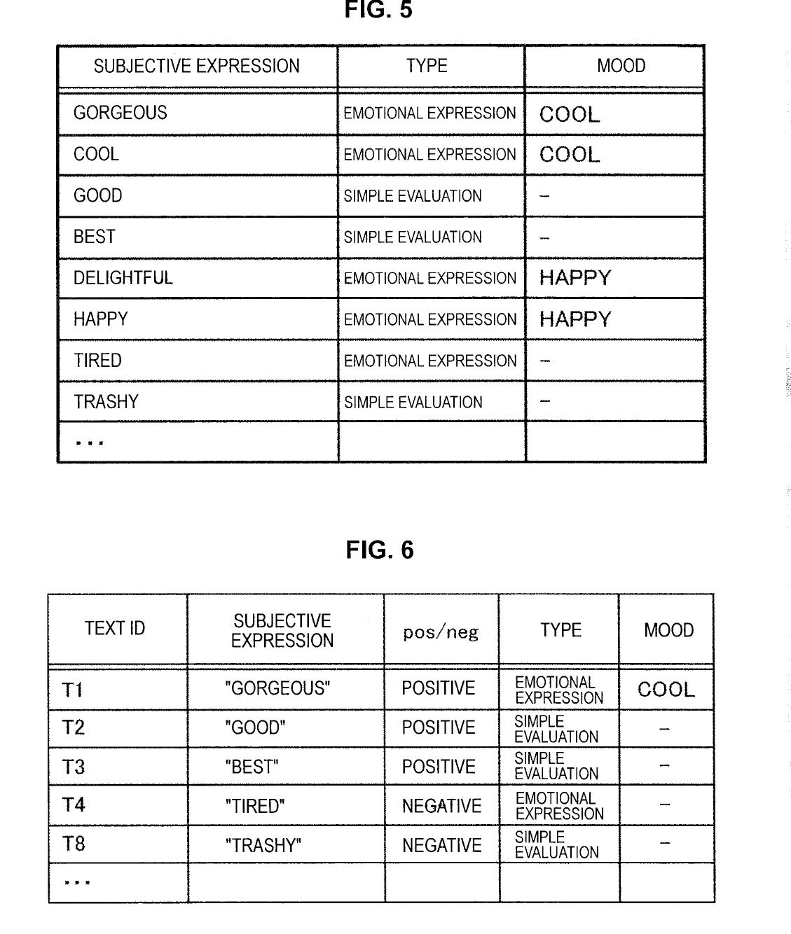

FIG. 6 shows a result that is obtained by executing the extraction processing of the subjective expression with respect to the text data T1 to T8 of FIG. 4, using the subjective expression dictionary of FIG. 5.

For example, subjective expressions of “gorgeous”, “good”, “best”, “tired”, and “trashy” are extracted from the text data T1, T2, T3, T4, and T8, respectively. Values of positive/negative, (pos/neg), a type, and a mood are given to each of the extracted subjective expressions. The subjective expressions are not extracted from the text data T5 to T7.

The subjective expression extracting unit 55 stores an extraction result of the subjective expressions in the subjective expression storage unit 56.

In step S3, the experience information extracting unit 57 extracts experience information. Specifically, the experience information extracting unit 57 extracts an experience related to content handled by the server 11 and a classification thereof, from the text data received by the processing of step S1 and stored in the text data storage unit 52, using a predetermined method. For example, the experience information extracting unit 57 extracts a model of a word by morphological analysis, from each text data. Then, the experience information extracting unit 57 extracts a specific experience and a classification thereof, using the experience classification dictionary stored in the dictionary storage unit 53.

FIG. 7 shows an example of a data configuration of the experience classification dictionary. In the experience classification dictionary, a phrase showing an experience assumed as the experience related to the content handled by the server 11 is registered and a classification of an experience shown by each phrase is defined.

In this example, phrases such as “listen”, “live”, and “sing” are registered. An experience classification of “listen” is classified into “LISTEN”. In addition, phrases relating to listening to music such as “hearing” and “listening” are classified into the experience classification “LISTEN”. An experience classification of “live” is classified into “JOIN”. In addition, phrases relating to participating in events such as “participating in a war” and “entering” are classified into the experience classification “JOIN”. An experience classification of “sing” is classified into “SING”. In addition, phrases relating to singing such as “humming” and “chorus” are classified into the experience classification “SING”.

The experience classifications that are shown in the above example are only exemplary and “BUY” (for example, buying a CD), “PLAY” (for example, playing a musical instrument), and “WATCH” (for example, watching a moving image) may be used as the experience classifications.

As a method of extracting experience information and a classification thereof from the text data, any method may be used. For example, the present disclosure is not limited to the above-described method and a large number of sample documents of experience classifications are prepared and each experience classification can be classified using a machine learning method described in “Sebastiani, F., “Machine Learning in Automated Text Categorization,” ACM Computing Surveys, Vol. 34, Issue 1, 2002”.

The experience information extracting unit 57 extracts information regarding a time from the text data, using the time information dictionary stored in the dictionary storage unit 53. In this case, it is assumed that the time information extracted from the text data is likely to show a time when the user has had the experience described in the same text data.

FIG. 8 shows an example of a data configuration of the time information dictionary. In the time information dictionary, expression patterns showing times are registered and specific time information shown by each expression pattern is defined.

In this example, expression patterns such as “now”, “yesterday”, “N days ago”, “N months ago”, “N years ago”, and “want” are registered. The “now” is defined as an expression pattern that shows 0 min (current). The “yesterday” is defined as an expression pattern that shows −1 day, the “N days ago” is defined as an expression pattern that shows −N day, the N months ago” is defined as an expression pattern that shows −N month, and the “N years ago” is defined as an expression pattern that shows −N year. The “want” is defined as an expression pattern that shows FUTURE.

The time information that is shown in the above example is only exemplary and information showing specific era, year, month, date, and time may be used as the time information.

The experience information extracting unit 57 extracts information regarding a place from the text data, using the place information dictionary stored in the dictionary storage unit 53. In this case, it is assumed that the place information extracted from the text data is likely to show a place where the user has had the experience described in the same text data.

FIG. 9 shows an example of a data configuration of the place information dictionary. In the place information dictionary, phrases relating to places are registered and each phrase is defined as a phrase showing a peculiar place or a general place.

In this example, phrases such as “Tokyo”, “Shonan coast”, “coffee shop”, and “return road” are registered. The “Tokyo” and “Shonan coast” are classified into the phrases showing the peculiar places and the “coffee shop”, and “return road” are classified into the phrases showing the general places.

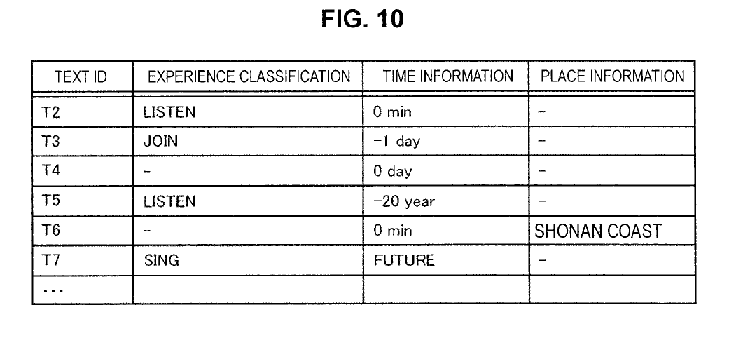

FIG. 10 shows a result that is obtained by executing the extraction processing of the experience information with respect to the text data T1 to T8 of FIG. 4, using the dictionaries of FIGS. 7 to 9.

For example, from the text data T2, the experience classification “LISTEN” is extracted on the basis of “listen” and the time information “0 min” is extracted on the basis of “now”.

From the text data T3, the experience classification “JOIN” is extracted on the basis of “live” and the time information “−1 day” is extracted on the basis of “yesterday”.

From the text data T4, the time information “0 day” is extracted on the basis of “today”.

From the text data T5, the experience classification “LISTEN” is extracted on the basis of “listen” and the time information “−20 year” is extracted on the basis of “twenty years ago”.

From the text data T6, the time information “0 min” is extracted on the basis of “during a drive” and the place information “Shonan coast” is extracted.

From the text data T7, the experience classification “SING” is extracted on the basis of “want to sing” and the time information “FUTURE” is extracted on the basis of “want to sing”.

From the text data T1 and T8, the experience classification, the time information, and the place information are not extracted.

The experience information extracting unit 57 stores an extraction result of the experience information in the experience information storage unit 58.

In step S4, the keyword extracting unit 59 extracts a keyword. Specifically, the keyword extracting unit 59 extracts a keyword peculiar to a category of content to be recommended for the user and the category of the keyword, from the text data received by the processing of step S1 and stored in the text data storage unit 52, using the keyword DB stored in the keyword storage unit 54.

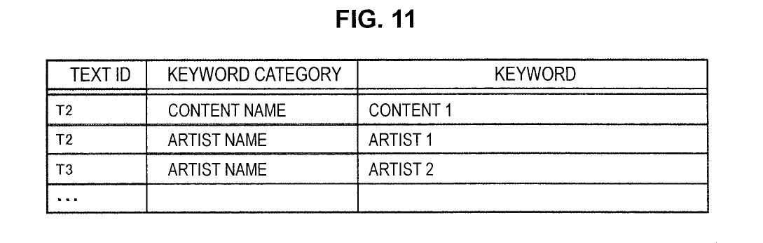

FIG. 11 shows an extraction result of keywords from the text data T1 to T8 of FIG. 4.

For example, from the text data T2, “content 1” of which a keyword category belongs to a “content name” is extracted and an “artist 1” of which a keyword category belongs to an “artist name” is extracted.

From the text data T3, an “artist 2” of which a keyword category belongs to the “artist name” is extracted.

From the text data T1 and T4 to T8, the keywords are not extracted.

The keyword extracting unit 59 stores the extraction result of the keyword in the extracted keyword storage unit 60.

In step S5, the recommended content control unit 71 selects the text data. That is, the commended content control unit 71 selects one non-processed text data among the text data stored in the text data storage unit 52 as a processing object.

Hereinafter, the text data that is selected as the processing object is referred to as object text data. Hereinafter, a user who corresponds to a source of the object text data is referred to as an object user.

In step S6, the recommended content extracting unit 81 executes recommended content extraction processing. That is, the recommended content extracting unit 81 extracts content to be commended for the object user (recommended content), from content of which information is stored in the content information storage unit 61, on the basis of the subjective expressions and the experience information extracted from the object text data.

At this time, all of the content of which the information is stored in the content information storage unit 61 may be set as extraction objects or the extraction objects may be confined to content satisfying a predetermined condition.

Hereinafter, a set of content becoming extraction objects of the recommended content is referred to as an extraction object content set.

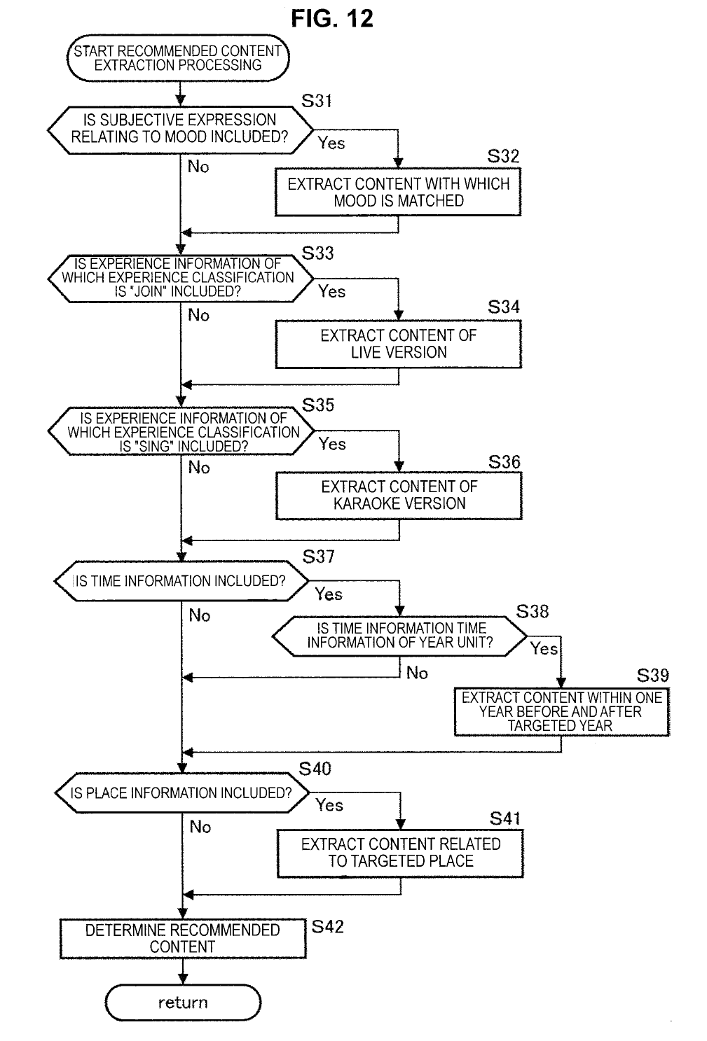

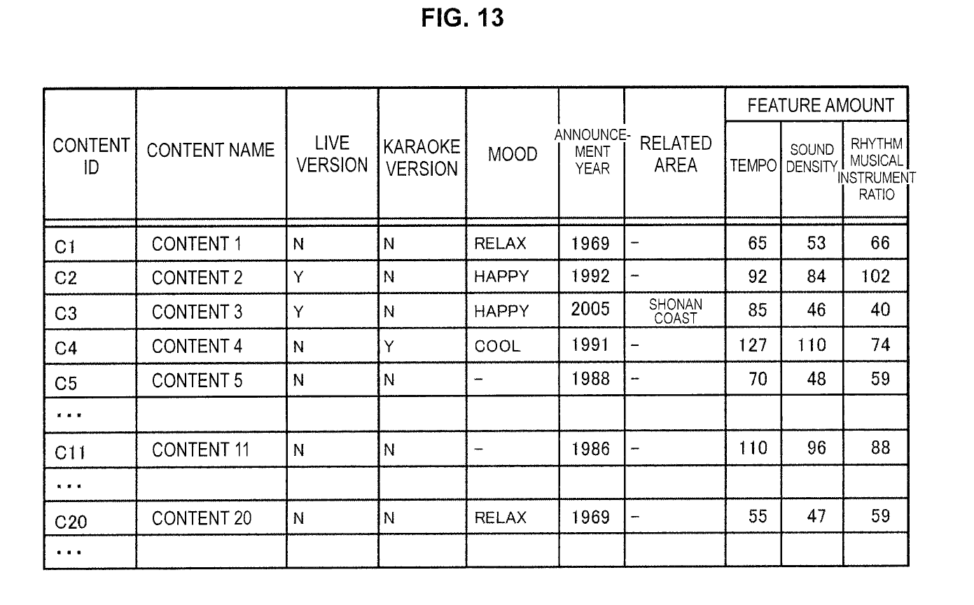

In this case, a specific example of the recommended content extraction processing will be described with reference to a flowchart of FIG. 12 and FIG. 13.

FIG. 13 shows an example of a configuration of the content information DB stored in the content information storage unit 61. The content information DB includes items of a content ID, a content name (musical composition name), a live version, a karaoke version, a mood, an announcement year, a related area, and a feature amount.

The content ID is identification information to identify each content.

The live version shows whether each content is of a live version. A value Y (Yes) is set to content of the live version and a value N (No) is set to content of a version other than the live version.

The karaoke version shows whether each content is of a karaoke version. A value Y (Yes) is set to content of the karaoke version and a value N (No) is set to content of a version other than the karaoke version.

The mood shows a mood of each content. For example, a mood suitable for each content among moods registered in the subjective expression dictionary of FIG. 5 is given manually or automatically by learning processing.

The announcement year shows an announced year of each content.

The related area shows an area to which each content is related. For example, an area appearing in a title or words of each content or a hometown of an artist is set as the related area.

The feature amount is an amount that is obtained by digitizing a feature of each content. In this case, feature amounts regarding a tempo, a sound density, and a rhythm musical instrument ratio are set.

In step S31, the recommended content extracting unit 81 determines whether a subjective expression relating to the mood is included in the object text data, on the basis of the extraction result of the subjective expression stored in the subjective expression storage unit 56.

For example, when the extraction result of the subjective expression of FIG. 6 is included, if the text data T1 is the object text data, it is determined that the subjective expression of the mood is included. Meanwhile, if the text data other than the text data T1 is the object text data, it is determined that the subjective expression of the mood is not included.

When it is determined that the subjective expression relating to the mood is included, the processing proceeds to step S32.

In step S32, the recommended content extracting unit 81 extracts content with which the mood is matched, from the extraction object content set. For example, when the text data T1 is the object text data, the mood of the subjective expression of the text data T1 is “COOL”. Therefore, content C4 in which “COOL” is set to the mood is extracted on the basis of the content information DB of FIG. 13.

Then, the processing proceeds to step S33.

Meanwhile, when it is determined in step S31 that the subjective expression relating to the mood is not included, the processing of step S32 is skipped and the processing proceeds to step S33.

In step S33, the recommended content extracting unit 81 determines whether the experience information in which the experience classification is “JOIN” is included in the object text data, on the basis of the extraction result of the experience information stored in the experience information storage unit 58.

For example, when the extraction result of the experience information of FIG. 10 is obtained, if the text data T3 is the object text data, it is determined that the experience information in which the experience classification is “JOIN” is included. Meanwhile, if the text data other than the text data T3 is the object text data, it is determined that the experience information in which the experience classification is “JOIN” is not included.

When it is determined that the experience information in which the experience classification is “JOIN” is included, the processing proceeds to step S34.

In step S34, the recommended content extracting unit 81 extracts the content of the live version from the extraction object content set. For example, when the text data T3 is the object text data, the pieces of content C2 and C3 in which “Y” is set to the live version in the content information DB of FIG. 13 are extracted.

Then, the processing proceeds to step S35.

Meanwhile, when it is determined in step S33 that the experience information in which the experience classification is “JOIN” is not included, the processing of step S34 is skipped and the processing proceeds to step S35.

In step S35, the recommended content extracting unit 81 determines whether the experience information in which the experience classification is “SING” is included in the object text data, on the basis of the extraction result of the experience information stored in the experience information storage unit 58.

For example, when the extraction result of the experience information of FIG. 10 is obtained, if the text data T7 is the object text data, it is determined that the experience information in which the experience classification is “SING” is included. Meanwhile, if the text data other than the text data T7 is the object text data, it is determined that the experience information in which the experience classification is “SING” is not included.

When it is determined that the experience information in which the experience classification is “SING” is included, the processing proceeds to step S36.

In step S36, the recommended content extracting unit 81 extracts the content of the karaoke version from the extraction object content set. For example, when the text data T7 is the object text data, the content C4 in which “Y” is set to the karaoke version in the content information DB of FIG. 13 is extracted.

Then, the processing proceeds to step S37.

Meanwhile, when it is determined in step S35 that the experience information in which the experience classification is “SING” is not included, the processing of step S36 is skipped and the processing proceeds to step S37.

In step S37, the recommended content extracting unit 81 determines whether the time information is included in the object text data, on the basis of the extraction result of the experience information stored in the experience information storage unit 58.

For example, when the extraction result of the experience information of FIG. 10 is obtained, if any one of the text data T2 to T7 is the object text data, it is determined that the time information is included. Meanwhile, if the other text data is the object text data, it is determined that the time information is not included.

When it is determined that the time information is included, the processing proceeds to step S38.

In step S38, the recommended content extracting unit 81 determines whether the time information is time information of a year unit.

For example, when the extraction result of the experience information of FIG. 10 is obtained, if the text data T5 is the object text data, it is determined that the time information is the time information of the year unit. Meanwhile, if the text data other than the text data T5 is the object text data, it is determined that the time information is not the time information of the year unit.

When it is determined that the time information is the time information of the year unit, the processing proceeds to step S39.

In step S39, the recommended content extracting unit 81 extracts content within one year before and after a targeted year, from the extraction object content set.

For example, when the text data 15 is the object text data, time information “−20 year” is included in the text data 15. Therefore, when a current year is 2012, content announced within one year before and after 1992 to be 20 years before 2012, that is, content of which announcement years are from 1991 to 1993 is extracted. For example, the pieces of content C2 and C4 of which announcement years are in a range from 1991 to 1993 in the content information DB of FIG. 13 are extracted.

Then, the processing proceeds to step S40.

Meanwhile, when it is determined in step S38 that the time information is not the time information of the year unit, the processing of step S39 is skipped and the processing proceeds to step S40.

When it is determined in step S37 that the time information is not included, the processing of steps S38 and S39 is skipped and the processing proceeds to step S40.

In step S40, the recommended content extracting unit 81 determines whether the place information is included in the object text data, on the basis of the extraction result of the experience information stored in the experience information storage unit 58.

For example, when the extraction result of the experience information of FIG. 10 is obtained, if the text data T6 is the object text data, it is determined that the place information is included. Meanwhile, if the text data other than the text data T6 is the object text data, it is determined that the place information is not included.

When it is determined that the place information is included, the processing proceeds to step S41.

In step S41, the recommended content extracting unit 81 extracts content relating to a targeted place, from the extraction object content set.

For example, when the text data T6 is the object text data, the place information “Shonan coast” is included in the text data T6. Therefore, the content C3 in which “Shonan coast” is set to the related area in the content information DB of FIG. 13 is extracted.

Then, the processing proceeds to step S42.

Meanwhile, when it is determined in step S40 that the place information is not included, the processing of step S41 is skipped and the processing proceeds to step S42.

In step S42, the recommended content extracting unit 81 determines recommended content. For example, when the recommended content extracting unit 81 executes at least one of the extraction processing of steps S32, S34, S36, S39, and S41, the recommended content extracting unit 81 determines the recommended content by any one of an OR condition and an AND condition. That is, when the OR condition is used, content that is extracted by any one of the executed extraction processing is determined as the recommended content. Meanwhile, when the AND condition is used, content that is extracted by all of the executed extraction processing is determined as the recommended content.

When the subjective expression and the experience information extracted from the object text data satisfy no condition and no extraction processing is executed, the recommended content extracting unit 81 determines all of the content included in the extraction object content set as the recommended content.

Then, the recommended content extraction processing ends.

Returning to FIG. 3, in step S7, the recommended content extracting unit 81 determines whether there is the recommended content, on the basis of the result of the processing of step S6. When it is determined that there is the recommended content, the processing proceeds to step S8.

In step S8, the recommended content extracting unit 81 notifies the ranking classification selecting unit 82 and the ranking creating unit 83 of the extraction result of the recommended content. The extraction result of the recommended content includes an ID of the recommended content.

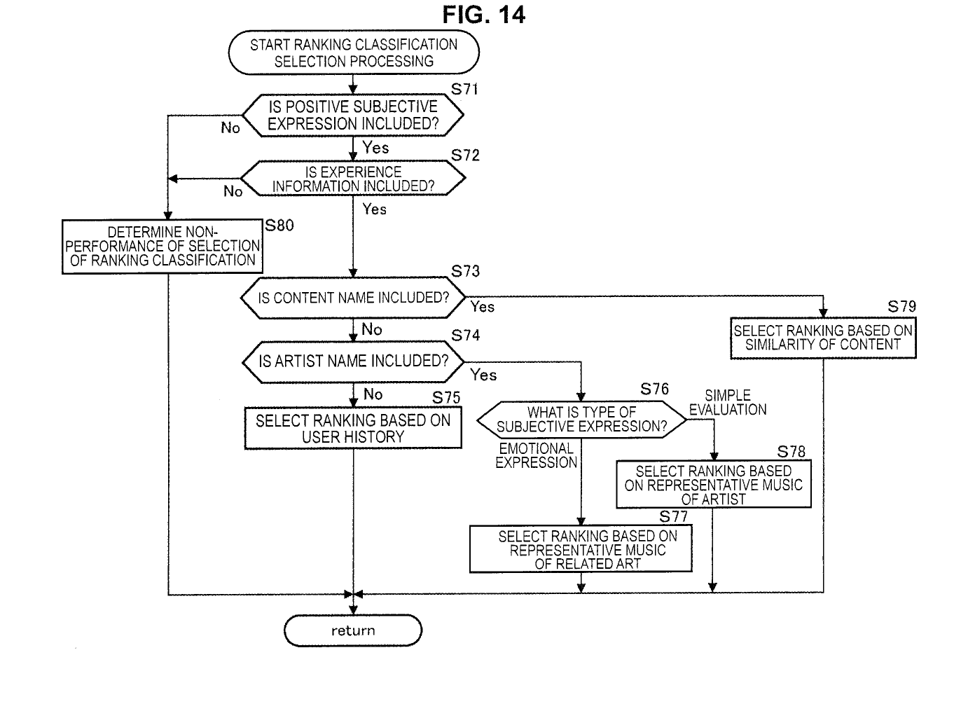

In step S9, the ranking classification selecting unit 82 executes ranking classification selection processing. In this case, the detail of the ranking classification selection processing will be described with reference to a flowchart of FIG. 14.

In step S71, the ranking classification selecting unit 82 determines whether the positive subjective expression is included in the object text data, on the basis of the extraction result of the subjective expression stored in the subjective expression storage unit 56. When it is determined that the positive subjective expression is included, the processing proceeds to step S72.

In step S72, the ranking classification selecting unit 82 determines whether the experience information is included in the object text data, on the basis of the extraction result of the experience information stored in the experience information storage unit 58. When it is determined that the experience information is included, the processing proceeds to step S73.

In step S73, the ranking classification selecting unit 82 determines whether the content name is included in the object text data, on the basis of the extraction result of the keyword stored in the extracted keyword storage unit 60. When it is determined that the content name is not included, the processing proceeds to step S74.

In step S74, the ranking classification selecting unit 82 determines whether the artist name is included in the object text data, on the basis of the extraction result of the keyword stored in the extracted keyword storage unit 60. When it is determined that the artist name is not included, the processing proceeds to step S75.

In step S75, the ranking classification selecting unit 82 selects the ranking based on the user history. That is, when the positive subjective expression and the experience information are included in the object text data, but the content name and the artist name are not included in the object text data, the ranking based on the content use history of the user (hereinafter, referred to as the user history ranking) is selected. For example, the case in which the object user has contributed text data of positive content with respect to an experience unrelated to specific content or a specific artist is assumed. In the text data T1 to T8 of FIG. 4, there is not text data in which the user history ranking is selected.

The ranking classification selecting unit 82 notifies the ranking creating unit 83 of the selected ranking classification.

Then, the ranking classification selection processing ends.

Meanwhile, when it is determined in step S74 that the artist name is included, the processing proceeds to step S76.

In step S76, the ranking classification selecting unit 82 determines whether the type of the subjective expression included in the object text data is the emotional expression or the simple evaluation, on the basis of the extraction result of the subjective expression stored in the objective expression storage unit 56. When it is determined that the type of the subjective expression is the emotional expression, the processing proceeds to step S77.

In step S77, the ranking classification selecting unit 82 selects the ranking based on representative music of the related artist. That is, when the subjective expression based on the positive emotional expression, the experience information, and the artist name are included in the object text data, but the content name is not included in the object text data, the ranking based on the representative music of the related artist (hereinafter, referred to as the related artist representative music ranking) is selected. For example, the case in which the object user has contributed text data of positive content by the emotional expression, regardless of specific content, with respect to an experience related to a specific artist, is assumed. In the text data T1 to T8 of FIG. 4, there is not text data in which the related artist representative music ranking is selected.

The ranking classification selecting unit 82 notifies the ranking creating unit 83 of the selected ranking classification.

Then, the ranking classification selection processing ends.

Meanwhile, when it is determined in step S76 that the type of the subjective expression is the simple evaluation, the processing proceeds to step S78.

In step S78, the ranking classification selecting unit 82 selects the ranking based on representative music of the artist. That is, when the subjective expression based on the positive simple evaluation, the experience information, and the artist name are included in the object text data, but the content name is not included in the object text data, the ranking based on the representative music of the artist (hereinafter, referred to as the artist representative music ranking) is selected. For example, the case in which the object user has contributed artist data of content showing a positive evaluation, regardless of specific content, with respect to an experience related to a specific artist, is assumed. When the text data T3 is the object text data, the artist representative music ranking is selected.

The ranking classification selecting unit 82 notifies the ranking creating unit 83 of the selected ranking classification.

Then, the ranking classification selection processing ends.

Meanwhile, when it is determined in step S73 that the content name is included, the processing proceeds to step S79.

In step S79, the ranking classification selecting unit 82 selects the ranking based on a similarity of content. That is, when the positive subjective expression, the experience information, and the content name are included in the object text data, the ranking based on the similarity of the content (hereinafter, referred to as the content similarity ranking) is selected. For example, the case in which the object user has contributed text data of positive content with respect to an experience related to specific content is assumed. When the text data T2 is the object text data, the content similarity ranking is selected.

The ranking classification selecting unit 82 notifies the ranking creating unit 83 of the selected ranking classification.

Then, the ranking classification selection processing ends.

Meanwhile, when it is determined in step S71 that the positive subjective expression is not included or it is determined in step S72 that the experience information is not included, the processing proceeds to step S80.

In step S80, the ranking classification selecting unit 82 determines non-performance of the selection of the ranking classification. That is, when the positive subjective expression and the experience information are not included in the object text data, the selection of the ranking classification is not performed. For example, the case in which the object user has contributed text data of content not related to an experience or the case in which the object user has contributed text data of negative content with respect to an experience is assumed. When the text data other than the text data T2 and T3 is the object text data, non-performance of the selection of the ranking classification is determined.

The ranking classification selecting unit 82 notifies the ranking creating unit 83 of non-performance of the selection of the ranking classification.

Then, the ranking classification selection processing ends.

Returning to FIG. 3, in step S10, the ranking creating unit 83 determines whether the ranking classification is selected, on the basis of the notification from the ranking classification selecting unit 82. When it is determined that the ranking classification is selected, the processing proceeds to step S11.

In step S11, the ranking creating unit 83 creates the ranking. That is, the ranking creating unit 83 predicts order which the object user is likely to like, on the basis of the selected ranking classification, with respect to the extracted recommended content, and creates the ranking in which the prediction result is reflected.

For example, when the user history ranking is selected, the ranking creating unit 83 predicts a preference degree of the object user with respect to each recommended content, on the basis of the use history of the content of the object user stored in the user history storage unit 62, using a predetermined method. In addition, the ranking creating unit 83 arranges the recommended content in order of the high preference degrees and creates the ranking of the recommended content.

As a method of predicting the preference degree of the user with respect to the content, any method may be adopted. For example, methods that are described in Su, X., Khoshgoftaar, T. M., “A Survey of Collaborative Filtering Techniques,” Advances in Artificial Intelligence, vol. 2009, 2009 and Adomavicius, G., Alexander, T., “Toward the Next Generation of Recommender Systems: A Survey of the State-of-the-Art and Possible Extensions,” IEEE Trans. Knowledge and Data Mining, Vol. 17, No. 6, 2005 may be adopted.

For example, when the related artist representative music ranking is selected, the ranking creating unit 83 searches a related artist who is related to an artist appearing in the object text data (hereinafter, referred to as the object artist).

As a method of searching the related artist, any method may be adopted. For example, the ranking creating unit 83 calculates similarities of feature amounts or metadata between the object artist and other artists, using the artist information DB stored in the artist information storage unit 63. In addition, the ranking creating unit 83 extracts the artists in which the similarities are equal to or more than a predetermined threshold value or the artists in which the similarities are from the top to the predetermined ranking, as the related artists.

Further, the related artists who are related to the object artist may be extracted using data showing a correlative relationship between the artists.

Next, the ranking creating unit 83 extracts content of the object artist and the related artists from the recommended content.

In addition, the ranking creating unit 83 creates the ranking of the extracted content, using the representative content DB stored in the content information storage unit 61.

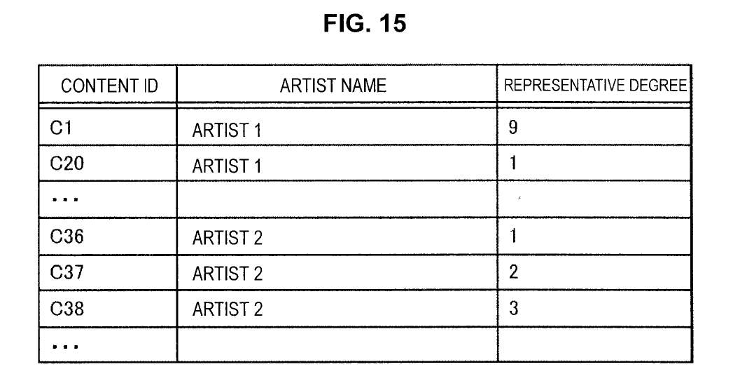

FIG. 15 shows a configuration example of the representative content DB. The representative content DB includes items of a content ID, an artist name, and a representative degree.

The representative degree is set for each artist, with respect to each content. If a value of the representative degree decreases, it shows representative content of the corresponding artist. For example, content of each artist may be arranged in order based on sales, the number of times of viewing content, and well-known degrees and the order may be set to the representative degree. Alternatively, the content of each artist may be classified into a plurality of levels based on sales, the number of times of viewing content, and well-known degrees and the representative degree may be set for each level. In the case of the former, a different representative degree may be set to each content of the same artist and in the case of the latter, the same representative degree may be set to a plurality of content of the same artist.

The ranking creating unit 83 arranges the extracted content in order of the representative degrees and creates the ranking of the recommended content.

For example, when the artist representative music ranking is selected, the ranking creating unit 83 extracts the content of the object artist appearing in the object text data, from the recommended content. The ranking creating unit 83 arranges the extracted content in order of the representative degrees, using the representative content DB of FIG. 15, and creates the ranking of the recommended content.

For example, when the content similarity ranking is selected, the ranking creating unit 83 calculates the similarity between the content appearing in the object text data and each recommended content, using the content information DB of FIG. 13.

As a method of calculating the similarity between the pieces of content, any method may be used. For example, the similarity between the pieces of content may be calculated on the basis of the feature amount of each content registered in the content information DB of FIG. 13. Also, the similarity between the pieces of content may be calculated, using item-based CF (Collaborative Filtering) described in Su, X., Khoshgoftaar, T. M., “A Survey of Collaborative Filtering Techniques,” Advances in Artificial Intelligence, vol. 2009, 2009.

The ranking creating unit 83 arranges the recommended content in order of the high similarities and creates the ranking of the recommended content.

In this way, priority setting of the recommended content to be provided to the object user is performed on the basis of the subjective expression and the experience information included in the text data contributed by the object user.

The ranking creating unit 83 associates ranking information showing the created ranking with information showing the object user and stores an association result in the ranking information storage unit 65.

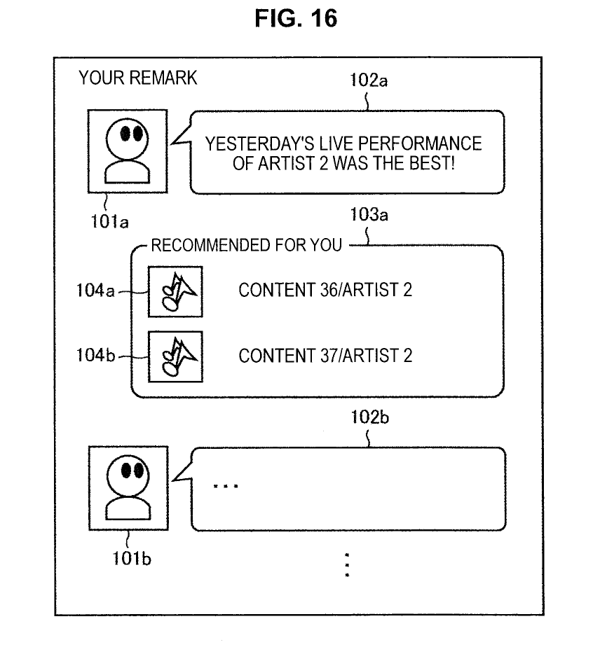

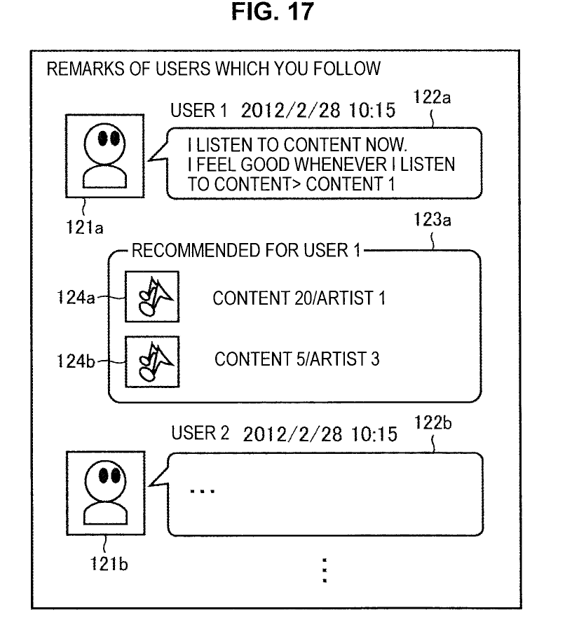

In step S12, the provision control unit 67 determines whether current timing is content recommendation timing. When it is determined that the current timing is the content recommendation timing, the processing proceeds to step S13. For example, as described below with reference to FIG. 16, when the content is recommended in real time in synchronization with contribution of the text data of the object user, in step S12, it is determined that the current timing is the content recommendation timing, immediately after the ranking is created.

In step S13, the provision control unit 67 provides content to be recommended, on the basis of the ranking. Specifically, the provision control unit 67 reads the ranking information with respect to the object user, from the ranking information storage unit 65. The provision control unit 67 generates display control data of a screen to provide the recommended content to the object user (hereinafter, referred to as the content recommendation screen), on the basis of on the basis of the ranking information. The provision control unit 67 transmits the display control data to the client 12 of the object user through the transmitting unit 68 and the network 13.

The client 12 that has received the display control data displays the content recommendation screen, on the basis of the received display control data. A specific example of the content recommendation screen will be described below with reference to FIGS. 16 to 18.

Then, the processing proceeds to step S14.

Meanwhile, when it is determined in step S12 that the current timing is not the content recommendation timing, the processing of step S13 is skipped and the processing proceeds to step S14.

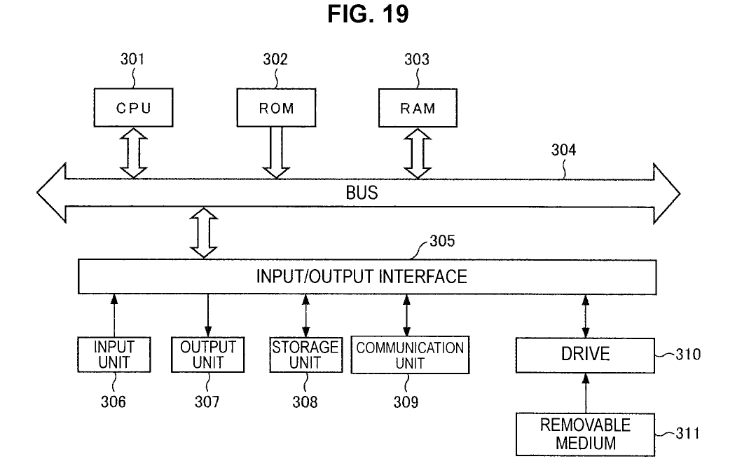

The ranking information that is not used due to skipping of the processing of step S13 is used when the current timing becomes the content recommendation timing thereafter. For example, as described below with reference to FIG. 18, the case in which content is collectively recommended on the basis of the text data contributed by the object user in the past is assumed.

When it is determined in step S10 that the ranking classification is not selected, the processing of steps S11 to S13 is skipped and the processing proceeds to step S14. That is, in this case, the content is not recommended.

When it is determined in step S7 that there is not the recommended content, the processing of steps S8 to S13 is skipped and the processing proceeds to step S14.

In step S14, the recommended content control unit 71 determines whether non-processed text data remains. When it is determined that the non-processed text data remains, the processing returns to step S5. Then, the processing of steps S5 to S14 is repetitively executed until it is determined in step S14 that the non-processed text data does not remain.

Meanwhile, when it is determined in step S14 that the non-processed text data does not remain, the content recommendation processing ends.

In this case, a specific example of the method of providing the recommended content will be described with reference to FIGS. 16 to 18.

FIG. 16 shows an example of a content recommendation screen displayed in the client 12, in a service (for example, music SNS (Social Networking Service) for providing recommended content (musical composition) according to content of text data, whenever the user contributes the text data.

The content recommendation screen displays the text data contributed by the object user in a form of a list. On the content recommendation screen, icons 101a and 101b, balloons 102a and 102b, a window 103a, and icons 104a and 104b are displayed.

The icons 101a and 101b are icons that show the object users.

In the balloons 102a and 102b, content of the text data that is contributed by the object users is displayed.

In the window 103a, recommended content of which extraction and priority setting have been performed on the basis of the text data in the balloon 102a is displayed. Specifically, the text data “yesterday's live performance of an artist 2 was the best!” in the balloon 102a includes a subjective expression (best) of a positive simple evaluation, an experience (live), and an artist name (artist 2). Therefore, in the ranking classification selection processing of FIG. 14 described above, the artist representative music ranking is selected.

As a result, in the window 103a, the content of the predetermined number that has the high representative degrees among the content of the artist 2 is displayed. In this case, content names of upper two pieces of content C36 and C37 among the representative content of the artist 2 are displayed on the basis of the representative content DB of FIG. 15. Further, the icons 104a and 104b that correspond to the pieces of content C36 and C37 are displayed. In the icons 104a and 104b, jackets of corresponding content (musical compositions) are used.

As such, the content according to the subjective expression and the experience information that are included in the text data contributed by the object user is recommended in real time. Therefore, the possibility of the object user receiving the recommended content becomes high. That is, the possibility of the object user using, buying, and evaluating the recommended content and reading information of the content becomes high.

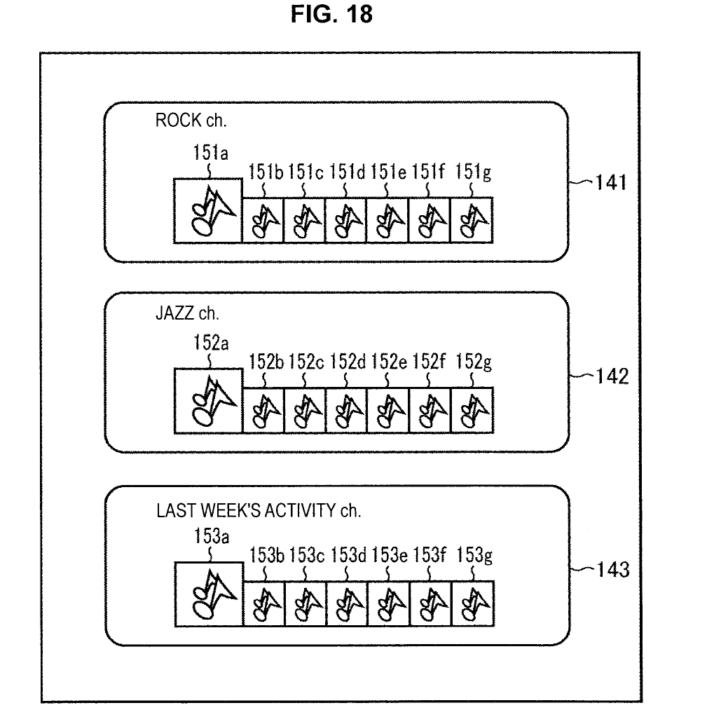

As shown in FIG. 17, content recommended with respect to not only the text data contributed by the object user but also the text data contributed by other users may be provided.

Specifically, FIG. 17 shows the case in which text data contributed by users which the object user follows is displayed in a form of a list. In this case, icons 121a and 121b, balloons 122a and 122b, a window 123a, and icons 124a and 124b are displayed.

In this case, the users which the object user follows are other users set by the object user to refer to the contributed text data.

The icons 121a and 121b are icons that show the users which the object user follows.

In the balloons 122a and 122b, content of the text data that is contributed by the users corresponding to the icons 121a and 121b is displayed. On each of the balloons 122a and 122b, a user name of a user who has contributed the text data and a date and time when the user has contributed the text data are displayed.

In the window 123a, recommended content that is provided to the user 1 on the basis of the text data in the balloon 122a is displayed. Specifically, the text data “I listen to content now. I feel good whenever I listen to content>content 1” in the balloon 122a includes a subjective expression (good) of a positive simple evaluation, an experience (listen), and a content name (content 1). Therefore, in the ranking classification selection processing of FIG. 14, the content similarity ranking is selected.

As a result, in the window 123a, the content of the predetermined number that has the high similarities with the content 1 is displayed. In this example, content names of upper two pieces of content C20 and C5 that have the high similarities of the feature amounts with the content 1 are displayed on the basis of the content information of FIG. 13. Further, the icons 124a and 124b that correspond to the pieces of content C20 and C5 are displayed. In the icons 124a and 124b, jackets of corresponding content (musical compositions) are used.

As such, the content recommended according to the subjective expression and the experience information that are included in the text data of the users which the object user follows is provided to the object user. Thereby, the object user can know the tastes of the users which the object user follows, with respect to the content. The users which the object user follows are likely to be users who have tastes or values matched with the taste or the values of the object user. Therefore, the possibility of the object user receiving the content recommended with respect to the users which the object user follows is high.

FIG. 18 shows an example of a screen displayed in the client 12 of the object user, when the server 11 provides a service for collecting content for each channel classified on the basis of a genre and providing the content, like Internet radio.

On the screen, windows 141 to 143 corresponding to individual channels are displayed. Among the windows 141 to 143, the windows 141 and 142 correspond to a rock channel and a jazz channel to be normal channels provided from the server 11. In the window 141, icons 151a to 151g that correspond to content distributed on the rock channel are arranged in reproduction order and are displayed. In the window 142, icons 152a to 152g that correspond to content distributed on the jazz channel are arranged in reproduction order and are displayed.

Meanwhile, the window 143 corresponds to a “last week's activity channel” in which content recommended on the basis of text data contributed by the object user last week is collected. In the window 143, icons 153a to 153g that correspond to content distributed on the last week's activity channel are arranged in reproduction order and are displayed. The distributed content and the reproduction order are determined on the basis of ranking information created on the basis of content of text data contributed by the object user through the social networking service (SNS), for the last week.

As such, content is collected and recommended, according to the subjective expressions and the experience information included in the text data contributed by the object user during a past predetermined period. Therefore, the possibility of the object user receiving the recommended content becomes high.

### 2. Modifications

Hereinafter, modifications of the embodiment of the present disclosure will be described.

### [First Modification: Modification of Method of Performing Extraction and Priority Setting of Content]

The method of extracting the content provided to the user and creating the ranking of the content (that is, setting priority) is not limited to the above-described example and any method may be adopted.

For example, the recommended content may be extracted and the ranking of the recommended content may be created, using conditions other than the above-described conditions.

For example, the conditions that are used for the extraction of the content in the above-described embodiment may be used for the creation of the ranking of the content. In contrast, the conditions that are used for the creation of the ranking of the content may be used for the extraction of the content.

For example, only the extraction of the content or the creation of the ranking of the content may be performed. With respect to all of the content in the extraction object content set, the ranking of the recommended content may be created. Alternatively, the recommended content may be only extracted from the content in the extraction object content set and the ranking may be created.

For example, the extraction of the recommended content or the creation of the ranking of the recommended content may be performed on the basis of only the experience information or the subjective expression extracted from the text data.

For example, when the phrase relating to the experience is not extracted from the text data, the experience information may not be used for the extraction of the recommended content and the creation of the ranking of the recommended content, even though the time information or the place information is extracted. This is because the time information or the place information extracted from the text data may not be information related to the experience.

### [Second Modification: Modification of Method of Recommending Content]

The method of providing the recommended content described above with reference to FIGS. 16 to 18 is exemplary and the recommended content may be provided using other methods.

For example, the ranking of the recommended content may be provided as it is.

For example, the provided recommended content may be changed for every predetermined time, according to the ranking.

In the example described above with reference to FIG. 18, the content has been collected and recommended, on the basis of the plurality of text data contributed by the object user during the past predetermined period. However, the present disclosure is not limited thereto and content may be collected and recommended, on the basis of a plurality of text data extracted on the basis of any other conditions. For example, the length of text data, a phrase included in the text data, a topic of conversation, and a contribution time or a contribution day of the week may be used as extraction conditions.

### [Third Modification: Modification of Method of Inputting Text Data]

The present disclosure can be applied to the case in which the user inputs the text data using a sound as well as the case in which the user inputs the text data to the client 12 directly. In this case, input sound data may be converted into text data at the client 12 and the text data may be transmitted to the server 11. Alternatively, sound data may be transmitted from the client 12 to the server 11 and the sound data may be converted into text data at the server 11.

### [Fourth Modification: Modification of Recommended Items]

The items that are recommended using the present disclosure are not limited to the above-described examples. For example, the present disclosure can be applied to the case of recommending various content using letters, sounds, and images such as books, games, software, websites, news, and advertisements, in addition to the music and the moving image.

The present disclosure can be applied to the case in which various items other than the content, for example, various commodities and users on a social service are recommended.

### [Fifth Modification: Modification of Keyword]

The example of the case in which the name of the artist of the content (musical composition) is extracted as the keyword and is used for the extraction of the recommended content or setting the priority of the recommended content has been described. However, people other than the artists or a group may be used as the keyword.

For example, names of people, a company, and a group relating to developing, making, and selling of the items may be used as the keyword. The name that is used for the keyword may not be an official name. For example, a popular name or an abbreviated name may be used.

### [Configuration Examples of Computer]

The above mentioned series of processes can be executed by hardware, or can be executed by software. In the case where the series of processes is executed by software, a program configuring this software is installed in a computer. Here, for example, a general purpose personal computer that can execute various functions is included in the computer, by installing a computer incorporated into specialized hardware and various programs.

FIG. 19 is a block diagram showing a configuration example of hardware of a computer executing the above series of processes by a program.

A CPU (Central Processing Unit) 301, a ROM (Read Only Memory) 302, a RAM (Random Access memory) 303, and a bus 304 are mutually connected in the computer.

An input/output interface 305 is further connected to the bus 304. An input unit 306, an output unit 307, a storage unit 308, a communication unit 309, and a drive 310 are connected to the input/output interface 305.

The input unit 306 includes a keyboard, a mouse, a microphone or the like. The output unit 307 includes a display, a speaker or the like. The storage unit 308 includes a hard disk, a nonvolatile memory or the like. The communication unit 309 includes a network interface or the like. The drive 310 drives a removable medium 311, such as a magnetic disk, an optical disk, a magneto-optical disk, or a semiconductor memory.

In a computer configured such as above, the above mentioned series of processes are executed, for example, by the CPU 301 loading and executing a program, which is stored in the storage unit 308, in the RAM 303 through the input/output interface 305 and the bus 304.

The program executed by the computer (CPU 301) can be, for example, recorded and provided in a removable medium 311 as a packaged medium or the like. Further, the program can be provided through a wired or wireless transmission medium, such as a local area network, the internet, or digital satellite broadcasting.

In the computer, the program can be installed in the storage unit 308 through the input/output interface 305, by installing the removable medium 311 in the drive 310. Further, the program can be received by the communication unit 309 through the wired or wireless transmission medium, and can be installed in the storage unit 308. Additionally, the program can be installed beforehand in the ROM 302 and the storage unit 308.

Note that the program executed by the computer may be a program which performs time series processes, in accordance with the order described in the present disclosure, or may be a program which performs the processes at a necessary timing in parallel, such as when calling is performed.

Further, in the present disclosure, a system has the meaning of a set of a plurality of configured elements (such as an apparatus or a module (part)), and does not take into account whether or not all the configured elements are in the same casing. Therefore, the system may be either a plurality of apparatuses, stored in separate casings and connected through a network, or a plurality of modules within a single casing.

It should be understood by those skilled in the art that various modifications, combinations, sub-combinations and alterations may occur depending on design requirements and other factors insofar as they are within the scope of the appended claims or the equivalents thereof.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Additionally, the present technology may also be configured as below.

(1) An information processing apparatus including:

an experience information extracting unit that extracts experience information which is information regarding an experience, from text data input from a user;

an item selecting unit that performs at least one of extraction and priority setting of an item to be provided to the user, based on the extracted experience information; and

a provision control unit that controls provision of the item to the user, based on a result of the extraction or the priority setting of the item.

(2) The information processing apparatus according to (1),

wherein the experience information extracting unit classifies an experience included in the experience information into a predetermined classification, and

wherein the item selecting unit performs at least one of the extraction and the priority setting of the item to be provided to the user, based on the classification of the experience.

(3) The information processing apparatus according to (1) or (2),

wherein the item selecting unit performs at least one of the extraction and the priority setting of the item to be provided to the user, based on a time or a place included in the experience information.

(4) The information processing apparatus according to any one of (1) to (3),

wherein the experience information is information regarding an experience related to the item.

(5) The information processing apparatus according to any one of (1) to (4), further including:

a subjective expression extracting unit that extracts a subjective expression from the text data,

wherein the item selecting unit performs at least one of the extraction and the priority setting of the item to be provided to the user, further based on the extracted subjective expression.

(6) The information processing apparatus according to (5),

wherein the item selecting unit performs at least one of the extraction and the priority setting of the item to be provided to the user, based on whether the subjective expression is positive or negative.

(7) The information processing apparatus according to (6),

wherein the item selecting unit performs at least one of the extraction and the priority setting of the item to be provided to the user, when the experience information and the subjective expression that is positive are extracted from the text data.

(8) The information processing apparatus according to any one of (5) to (7),

wherein the item selecting unit performs at least one of the extraction and the priority setting of the item to be provided to the user, based on a mood shown by the subjective expression.

(9) The information processing apparatus according to any one of (5) to (8),

wherein the item selecting unit performs at least one of the extraction and the priority setting of the item to be provided to the user, based on whether the subjective expression is a simple evaluation or an emotional expression.

(10) The information processing apparatus according to any one of (1) to (9), further including:

a keyword extracting unit that extracts a keyword from the text data,

wherein the item selecting unit performs at least one of the extraction and the priority setting of the item to be provided to the user, based on the extracted keyword.

(11) The information processing apparatus according to (10),

wherein the keyword includes a name of the item, and

wherein the item selecting unit performs at least one of the extraction and the priority setting of the item to be provided to the user, based on the name of the item extracted as the keyword.

(12) The information processing apparatus according to (10) or (11),

wherein the keyword includes a name of a person related to the item, and

wherein the item selecting unit performs at least one of the extraction and the priority setting of the item to be provided to the user, based on the name of the person extracted as the keyword.

(13) The information processing apparatus according to any one of (1) to (12),

wherein the provision control unit performs control in a manner that an item of which extraction or priority setting has been performed is provided together with the text data.

(14) The information processing apparatus according to any one of (1) to (12),

wherein the provision control unit performs control in a manner that an item of which extraction or priority setting has been performed based on a plurality of pieces of the text data satisfying a predetermined condition is collected and is provided to the user.

(15) An information processing method performed by an information processing apparatus, the method including:

extracting experience information which is information regarding an experience, from text data input from a user;

performing at least one of extraction and priority setting of an item to be provided to the user, based on the extracted experience information; and

controlling provision of the item to the user, based on a result of the extraction or the priority setting of the item.

(16) A program for causing a computer to execute processing including:

extracting experience information which is information regarding an experience, from text data input from a user;

performing at least one of extraction and priority setting of an item to be provided to the user, based on the extracted experience information; and

controlling provision of the item to the user, based on a result of the extraction or the priority setting of the item.

The present disclosure contains subject matter related to that disclosed in Japanese Priority Patent Application JP 2012-120725 filed in the Japan Patent Office on May 28, 2012, the entire content of which is hereby incorporated by reference.

What is claimed is:

1. An information processing apparatus comprising:
an experience information extracting unit that extracts experience information which is information regarding an experience, from text data input from a user;
an item selecting unit that performs at least one of extraction and priority setting of an item to be provided to the user, based on the extracted experience information; and
a provision control unit that controls provision of the item to the user, based on a result of the extraction or the priority setting of the item.

2. The information processing apparatus according to claim 1,
wherein the experience information extracting unit classifies an experience included in the experience information into a predetermined classification, and
wherein the item selecting unit performs at least one of the extraction and the priority setting of the item to be provided to the user, based on the classification of the experience.

3. The information processing apparatus according to claim 1,
wherein the item selecting unit performs at least one of the extraction and the priority setting of the item to be provided to the user, based on a time or a place included in the experience information.

4. The information processing apparatus according to claim 1,
wherein the experience information is information regarding an experience related to the item.

5. The information processing apparatus according to claim 1, further comprising:
a subjective expression extracting unit that extracts a subjective expression from the text data,
wherein the item selecting unit performs at least one of the extraction and the priority setting of the item to be provided to the user, further based on the extracted subjective expression.

6. The information processing apparatus according to claim 5,
wherein the item selecting unit performs at least one of the extraction and the priority setting of the item to be provided to the user, based on whether the subjective expression is positive or negative.

7. The information processing apparatus according to claim 6,
wherein the item selecting unit performs at least one of the extraction and the priority setting of the item to be provided to the user, when the experience information and the subjective expression that is positive are extracted from the text data.

8. The information processing apparatus according to claim 5,
wherein the item selecting unit performs at least one of the extraction and the priority setting of the item to be provided to the user, based on a mood shown by the subjective expression.

9. The information processing apparatus according to claim 5,
wherein the item selecting unit performs at least one of the extraction and the priority setting of the item to be provided to the user, based on whether the subjective expression is a simple evaluation or an emotional expression.

10. The information processing apparatus according to claim 1, further comprising:
a keyword extracting unit that extracts a keyword from the text data,
wherein the item selecting unit performs at least one of the extraction and the priority setting of the item to be provided to the user, based on the extracted keyword.

11. The information processing apparatus according to claim 10,
wherein the keyword includes a name of the item, and
wherein the item selecting unit performs at least one of the extraction and the priority setting of the item to be provided to the user, based on the name of the item extracted as the keyword.

12. The information processing apparatus according to claim 10,
wherein the keyword includes a name of a person or a group related to the item, and
wherein the item selecting unit performs at least one of the extraction and the priority setting of the item to be provided to the user, based on the name of the person or the group extracted as the keyword.

13. The information processing apparatus according to claim 1,
wherein the provision control unit performs control in a manner that an item of which extraction or priority setting has been performed is provided together with the text data.

14. The information processing apparatus according to claim 1,
wherein the provision control unit performs control in a manner that an item of which extraction or priority setting has been performed based on a plurality of pieces of the text data satisfying a predetermined condition is collected and is provided to the user.

15. An information processing method performed by an information processing apparatus, the method comprising:
extracting experience information which is information regarding an experience, from text data input from a user;
performing at least one of extraction and priority setting of an item to be provided to the user, based on the extracted experience information; and
controlling provision of the item to the user, based on a result of the extraction or the priority setting of the item.

16. A program for causing a computer to execute processing including:
extracting experience information which is information regarding an experience, from text data input from a user;
performing at least one of extraction and priority setting of an item to be provided to the user, based on the extracted experience information; and
controlling provision of the item to the user, based on a result of the extraction or the priority setting of the item.
